(19) United States
(12) Patent Application Publication
(10) Pub. No.: US 2007/0118503 A1
(43) Pub. Date: May 24, 2007

(54) Methods and systems for providing data to a database

(76) Inventor: Stephen P. Connelly, Reston, VA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/285,515

(22) Filed: Nov. 22, 2005

(51) Int. Cl. G06F 17/30

(52) U.S. Cl. 707/2

(57) ABSTRACT

Methods and systems for providing data, generated by a computer application, to a database.

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

As the use of computer applications in monitoring processes or events, such as network transmission events, proliferates, the volume of data generated and the rate of data generation increases. It is desirable to store the data generated by computer applications in order to be able, among other uses, to analyze data and compare it to previously obtained data. However, data storage in the digital age continues to be problematic due to differences in platforms, systems, and formats. These differences make it difficult to effectively store large volumes of data.

Therefore, there is a need for methods and systems for storing data, generated by computer applications, in databases.

### BRIEF SUMMARY OF THE INVENTION

An embodiment of the method of this invention for providing data, generated by computer application, to a database includes the steps of encoding the data according to predetermined encoding rules and transferring the encoded data to the database. The encoding of the data and the transfer of the encoded data to the database are performed by a computer system.

In one instance, an embodiment of the method of this invention also includes instead of developing a mapping from the encoded data to a database schema and storing the data according to the database schema. The development of the mapping and the storing of the data are performed by a computer system.

In another instance, the method of this invention also includes the step of transmitting in the encoded data over a network.

System that implement the method of this invention and computer program products including computer usable media having computer readable code embodied therein that causes a computer system to implement the method of this invention are also disclosed.

For a better understanding of the present invention, together with other and further needs thereof, reference is made to the accompanying drawings and detailed description and its scope will be pointed out in the appended claims.

### BRIEF DESCRIPTION OF THE DRAWINGS

FIG. 1 is a schematic flowchart representation of an embodiment of the method of this invention;

FIG. 2 is a schematic block diagram representation of an embodiment of the system of this invention; and

FIG. 3 is a schematic block diagram representation of another embodiment of the system of this invention

### DETAILED DESCRIPTION OF THE INVENTION

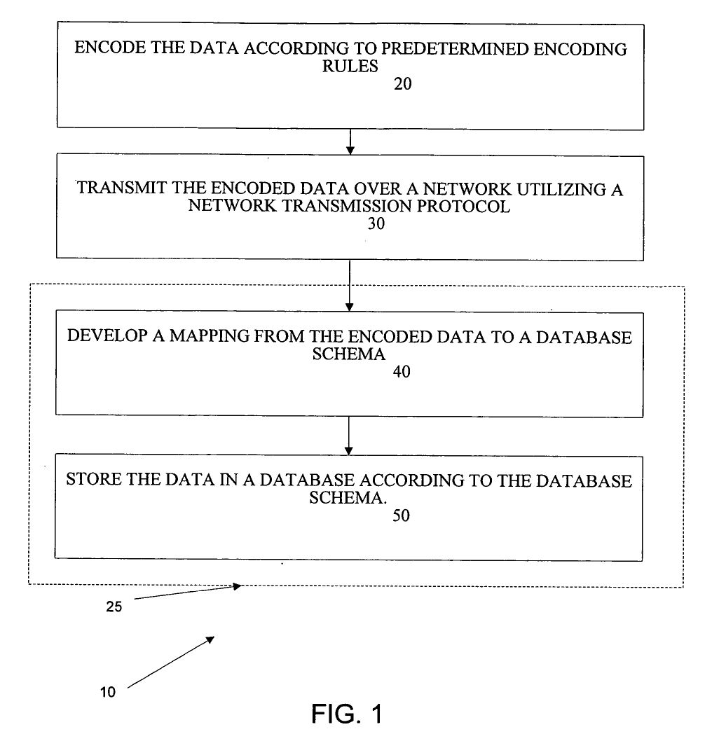

A block diagram representation of an embodiment of the method of this invention is shown in FIG. 1. Referring to FIG. 1, in the embodiment 10 shown therein, the data, generated by a computer application, is encoded according to predetermined encoding rules (step 20, FIG. 1). The encoded data is transmitted over a network wherein the transmission occurs according to a network transmission protocol (step 30, FIG. 1). In one embodiment, the encoding of the data includes rendering the encoded data according to (in a form amenable to) the network transmission protocol. Exemplary network transmission protocols include, but are not limited to, TCP, UDP, HTTP, and others. At the receiving node of the network, a mapping is developed from the encoded data to a database schema (step 40, FIG. 1). The data is stored in a database according to the database schema (step 50, FIG. 1). Steps 40 and 50 of FIG. 1 represent one embodiment of the step of transferring the encoded data to the database (labeled as step 25, FIG. 1).

It should be noted that embodiments in which the data is not transmitted over a network are also within the scope of this invention. (In such embodiments, step 30 is omitted.)In one embodiment, the database is made up of one or (usually) more tables. Each table is a set of records or rows having data in a defined set of columns. The data in each column is defined to be of a certain type, and may also have value restrictions, such as uniqueness or not null. Indexes can be defined on certain table columns. This information about the database is provided by the database schema.

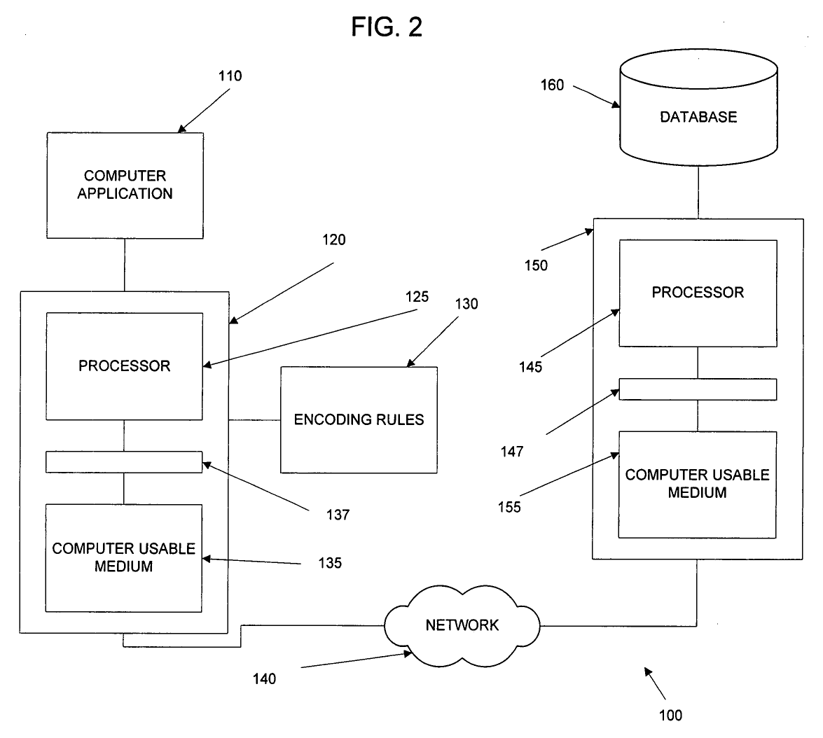

A block diagram representation of an embodiment of the system of this invention is shown in FIG. 2. Referring to FIG. 2, in the embodiment 100 shown therein, a computer application 110 generates data that is provided to the subsystem 120. The subsystem 120 includes a processor 125 operatively connected to a computer usable medium 135 by means of an interconnection component (such as, but not limited to, a computer bus). In the embodiment 100 shown in FIG. 2, the computer usable medium 135 has computer readable code embodied therein that is capable of causing the processor 125 to encode the data according to predetermined encoding rules 130 and to transmit the encoded data over a network 140. It should be noted that, in one embodiment, this invention not being limited only to that embodiment, the computer readable code parses or applies a data filter to the data and outputs the encoded data.

The transmitted encoded data is received by another subsystem 150. The other subsystem 150 includes another processor 145 operatively connected, by means of connection component 147, to another computer usable medium 155. The other computer usable medium 155 has computer readable code embodied therein that causes the other processor 145 to receive the encoded data, and transfer the encoded data to a database 160. In one embodiment, the computer readable code, in causing the other processor 145 to transfer the encoded data to the database 160, is capable of causing the other processor 145 to develop a mapping from the encoded data to a database schema, and store to data in a database 160. It should be noted that, in one embodiment (for example, for a relational database), this invention not being limited only to that embodiment, the mapping from the encoded data to the database schema can be a table based mapping. In table based mapping, the encoded data is considered as providing information for a single table or a set of tables and that provided information is mapped into the database schema. It should be noted that other mappings from the encoded data to the database schema, such as, but not limited to, object relational mappings, are within the scope of this invention. (See, for example, Ronald Bourret, XML and Databases (2004), which incorporated by reference herein.) It should also be noted that, in embodiments that utilize XML for encoding the data, mappings from an XML schema (an XML schema such as, but not limited to, DTD or XML Schema) to a database schema are also within the scope of this invention.

In order to better illustrate the methods and systems of this invention, an exemplary embodiment is presented herein below. It should be noted that the methods and systems of this invention are not limited to only this embodiment.

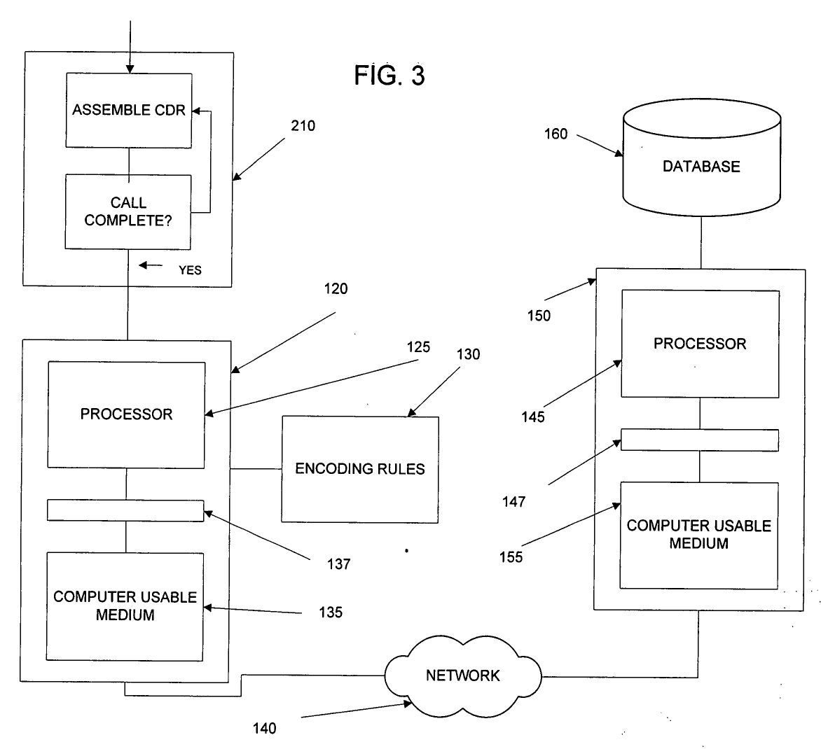

In the exemplary embodiment, a computer application obtains data related to network transmission events. It is the object of this exemplary embodiment to store the data, for each network transmission event analyzed, in a database. In this exemplary embodiment, the data is collected by an instrument such as, but not limited to, a network analyzer (such as the “J6800A Network Analyzer” of AGILENT TECHNOLOGIES, Inc.) and analyzed by a software (or hardware) application designed to analyze the data from the data collection instrument (or to run on the data collection instrument as a platform, such as for example the “J5486A Signaling Analyzer” of AGILENT TECHNOLOGIES, Inc.). In the exemplary embodiment, shown in FIG. 3, data for a network event, a “call” in a VoIP or wireless network in the exemplary embodiment shown, is obtained from the data analysis application 210. (In one embodiment, computer readable code embodied in a computer usable medium causes a computer subsystem including processing elements to obtain the data from the data analysis application 210.) In the exemplary embodiment, the encoding rules utilize a generalized markup language, XML, in the encoding of data. The use of an XML format enables rendering the encoded data according to (in a form amenable to) a network protocol such as the TCP protocol. Computer readable code embodied in a computer usable medium causes a computer subsystem (including processing elements) to encode the network event data in the XML format and to render the encoding data according to the network protocol. The XML format used in the exemplary embodiment includes two main elements, “lore ” and “ data unit.”

Exemplary encoding rules based on a XML format are shown herein below.

Lore

The “lore ” contains header information regarding the type of message, name and version of the message. This information is used in the header portion of the protocol and enables used receiving and retrieving the information transported according to the protocol.

| | |
|---|---|
| − | <lore> |
| | <updated>1</updated> |
| | <version>2.0</version> |
| | <profile>ITU 2000 ISUP</profile> |
| | <id>198</id> |

</lore>

Dataunit

The ‘Dataunit’consists of “field”, this is the data that is data transmitted according to the protocol, the “position ” states the position in the transmission according to the protocol, “name ” is a user friendly description, “dataid ” is used as a cross reference for applications, “type ” is the type of data, such as string, integer, timestamp, ip address and duration, and “length ” is the size of the new data of the “type”.

| | |
|---|---|
| − | <field position=“1”> |

<name>Cleardown Time</name>
<dataid>2008</dataid>
<type>duration</type>
<length>4</length>

</field>

Exemplary data encoded in a XML file is shown herein below.

| <?xml version=“1.0” encoding=“UTF-8” standalone=“no” ?> | |
|---|---|
| − | <callflowprotocol> |
| − | <lore> |
| | <updated>1</updated> |
| | <version>2.0</version> |
| | <profile>ITU 2000 ISUP</profile> |
| | <id>198</id> |
| </lore> | |
| − | <dataunit> |
| − | <field position=“1”> |

<name>Cleardown Time</name>
<dataid>2008</dataid>
<type>duration</type>
<length>4</length>

</field>

| − | <field position=“2”> |
|---|---|
| | <name>Setup Time</name> |
| | <dataid>2006</dataid> |
| | <type>duration</type> |
| | <length>4</length> |
| </field> | |
| − | <field position=“3”> |
| | <name>OPC</name> |
| | <dataid>2001</dataid> |
| | <type>int</type> |
| | <length>4</length> |
| </field> | |
| − | <field position=“4”> |
| | <name>DPC</name> |
| | <dataid>2002</dataid> |
| | <type>int</type> |
| | <length>4</length> |
| </field> | |
| − | <field position=“5”> |
| | <name>CIC</name> |
| | <dataid>2005</dataid> |
| | <type>int</type> |
| | <length>4</length> |
| </field> | |
| − | <field position=“6”> |
| | <name>Calling Party Number</name> |
| | <dataid>2003</dataid> |
| | <type>string</type> |
| | <length>25</length> |
| </field> | |
| − | <field position=“7”> |
| | <name>Called Party Number</name> |
| | <dataid>2004</dataid> |
| | <type>string</type> |
| | <length>25</length> |
| </field> | |
| − | <field position=“8”> |
| | <name>Release Cause</name> |
| | <dataid>2010</dataid> |
| | <type>int</type> |
| | <length>4</length> |
| </field> | |
| − | <field position=“9”> |

<name>Start Time</name>
<dataid>2020</dataid>
<type>timestamp</type>
<length>4</length>

</field>
</dataunit>
</callflowprotocol>

In the exemplary embodiment, the data encoded in the XML file given hereinabove is rendered according to the protocol, TCP, transmitted over the network and received at a receiving node of the network.

From the XML file a database schema can be generated and used for storing the messages; the database schema is a mapping of the data transmitted over to network according to the protocol. When the transmitted data is received, it then can be mapped to a row and each column in the database according to the database schema.

An exemplary embodiment of a schema is shown herein below.

insert into call_trace_profile values ( 198,

‘ITU 2000 ISUP’,
‘ITU_2000_ISUP’,
‘2.0’,
‘create table ITU_2000_ISUP_%s (

id bigint not null
auto_increment,
sart_instance_id integer not null,
sal_file_id integer not null,
call_id integer not null,
duration integer not null,
Start_Time timestamp not null,
Cleardown_Time integer,
Setup_Time integer,
OPC integer,
DPC integer,
CIC integer,
Calling_Party_Number varchar(25) not null,
Called_Party_Number varchar(25) not null,
Release_Cause integer,
call_phase1 varchar(201) not null,
call_phase2 varchar(201) not null,
successful integer not null,
primary key (id),
index (Start_Time, Calling_Party_Number),
index (Start_Time, Called_Party_Number)

)TYPE=InnoDB;’ );

commit;
insert into call_trace_table_columns values (198, 1, 2020,
‘Start_Time’, 4, ‘Start Time’, 1 ,0, 0 );
insert into call_trace_table_columns values (198, 2, 2008,
‘Cleardown_Time’, 3, ‘Cleardown Time’, 0 ,0, 0 );
insert into call_trace_table_columns values (198, 3, 2006,
‘Setup_Time’, 3, ‘Setup Time’, 0 ,0, 0 );
insert into call_trace_table_columns values (198, 4, 2001,
^{‘}OPC’, 1, ‘OPC’, 0 ,0, 0 );
insert into call_trace_table_columns values (198, 5, 2002,
^{‘}DPC’, 1, ‘DPC’, 0 ,0, 0 );
insert into call_trace_table_columns values (198, 6, 2005,
‘CIC’, 1, ‘CIC’, 0 ,0, 0 );
insert into call_trace_table_columns values (198, 7, 2003,
‘Calling_Party_Number’, 5, ‘Calling Party Number’, 1 ,0, 0 );
insert into call_trace_table_columns values (198, 8, 2004,
‘Called_Party_Number’, 5, ‘Called Party Number’, 1 ,0, 0 );
insert into call_trace_table_columns values (198, 9, 2010,
‘Release_Cause’, 1, ‘Release Cause’, 0 ,27, 1 );
commit;

It should be noted that, although the invention has been described in terms of an exemplary embodiment utilizing a specific generalized markup language, XML, this is not a limitation of the invention and other generalized markup languages and sources of metadata are within the scope of this invention.

It should also be noted that, although the invention has been described in terms of an exemplary embodiment utilizing a specific network protocol, TCP, this is not a limitation of the invention and other network protocols are within the scope of this invention.

In general, the techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to data entered using the input device to perform the functions described and to generate output information. The output information may be applied to one or more output devices. Under the scope of this invention, any software or program code is embodied in a computer usable medium and any implementation of the techniques described above in software is an implementation utilizing a computer usable medium having the software or program code embodied therein.

A computer system or subsystem as used herein includes one or more processors and may be distributed (that is, may have the one or more processors at different locations), may include a network or may have the one or more processors communicating by means of carrier waves and may include a network utilizing a TCP protocol, such as, but not limited to, the Internet.

Elements and components described herein may be further divided into additional components or joined together to form fewer components for performing the same functions.

Each computer program (code) within the scope of the claims below may be implemented in any programming language, such as assembly language, machine language, a high-level procedural programming language, or an object-oriented programming language. The programming language may be a compiled or interpreted programming language.

Each computer program may be implemented in a computer program product tangibly embodied in a computer-readable storage device for execution by a computer processor. Method steps of the invention may be performed by a computer processor executing a program tangibly embodied on a computer-readable medium to perform functions of the invention by operating on input and generating output.

Common forms of computer-readable or usable media include, for example, a floppy disk, a flexible disk, hard disk, magnetic tape, or any other magnetic medium, a CDROM, any other optical medium, punched cards, paper tape, any other physical medium with patterns of holes, a RAM, a PROM, and EPROM, a FLASH-EPROM, any other memory chip or cartridge, a carrier wave, or any other medium from which a computer can read.

Although the invention has been described with respect to various embodiments, it should be realized this invention is also capable of a wide variety of further and other embodiments within the spirit and scope of the appended claims.

What is claimed is:

1. A method for providing data, generated by a computer application, to a database, the method comprising the steps of:
encoding the data according to predetermined encoding rules;
developing a mapping from the encoded data to a database schema; and
storing the data in the database according to the database schema;
wherein the encoding of the data, the developing of the mapping and the storing of the data in the database are performed by a computer system.

2. The method of claim 1 wherein the step of encoding the data comprises a step of rendering the encoded data according to a network transmission protocol.

3. The method of claim 2 further comprising the step of:
transmitting the encoded data over a network;
wherein the data is stored after transmission.

4. The method of claim 1 wherein the step of encoding the data comprises the step of utilizing a generalized markup language in the encoding of the data.

5. The method of claim 4 wherein the generalized markup language is XML.

6. The method of claim 1 further comprising the step of obtaining the data is from a network transmission event.

7. A system for storing data generated by a computer application, the system comprising:
at least one processor;
at least one computer usable medium having computer readable code embodied therein, said computer readable code be capable of causing said at least one processor to:
encode the data according to predetermined encoding rules;
develop a mapping from said encoded data to a database schema; and
store the data in a database according to said database schema.

8. The system of claim 7 further comprising:
a computer readable memory for storing data, said computer readable memory comprising:
a data structure stored in said computer readable memory, said data structure including information resident in the database.

9. The system of claim 7 wherein said computer readable code is further capable of causing said at least one processor to:
transmit said encoded data over a network utilizing a network transmission protocol;
wherein the data is stored after transmission.

10. The system of claim 7 wherein said computer readable code, in causing said at least one processor to encode the data, is capable of causing said at least one processor to utilize a generalized markup language in encoding the data.

11. The system of claim 10 wherein the generalized markup language is XML.

12. The system of claim 7 wherein the data is data related to a network transmission event.

13. A computer program product comprising:
a computer usable medium having computer readable code embodied therein, said computer readable code be capable of causing a computer system to:
encode data according to predetermined encoding rules;
develop a mapping from said encoded data to a database schema; and
store the data in the database according to said database schema.

14. The computer program product of claim 13 wherein said computer readable code is further capable of causing said computer system to:
transmit said encoded data over a network utilizing a network transmission protocol;
wherein the data is stored after transmission.

15. The computer program product of claim 13 wherein said computer readable code, in causing said computer system to encode the data, is capable of causing said computer system to utilize a generalized markup language in encoding the data.

16. The computer program product of claim 13 wherein said generalized markup language is XML.

17. The computer program product of claim 13 wherein the data is data related to a network transmission event.
